(19) United States
(12) Patent Application Publication
(10) Pub. No.: US 2001/0028718 A1
(43) Pub. Date: Oct. 11, 2001

(54) Null adaptation in multi-microphone directional system

(75) Inventor: Zezhang Hou, Cupertino, CA (US)

Correspondence Address: BEYER WEAVER & THOMAS LLP, P.O. BOX 778, BERKELEY, CA, 94704-0778, US

(73) Assignee: Audia Technology, Inc.

(21) Appl. No.: 09/788,271

(22) Filed: Feb. 16, 2001

Related U.S. Application Data
(60) Provisional application No. 60/183,241, filed on Feb. 17, 2000.

(51) Int. Cl. H04R 3/00

(52) U.S. Cl. 381/92

(57) ABSTRACT

Improved approaches to adaptively suppress interfering noise in a multi-microphone directional system are disclosed. These approaches operate to adapt the direction null for the multi-microphone directional system in accordance with a dominant noise source.

### CROSS-REFERENCE TO RELATED APPLICATION

This application claims the benefit of U.S. Provisional Application No. 60/183,241, filed Feb. 17, 2000, and entitled “METHODS FOR NULL ADAPTATION IN MULTI-MICROPHONE DIRECTIONAL SYSTEM”, the contents of which is hereby incorporated by reference.

### BACKGROUND OF THE INVENTION

1. Field of the Invention

The present invention relates to noise suppression and, more particularly, to noise suppression for multi-microphone sound pick-up systems.

2. Description of the Related Art

Suppressing interfere noise is still a major challenge for most communication devices involving a sound pick up system such as a microphone or a multi-microphone array. The multi-microphone array can selectively enhance sounds coming from certain directions while suppressing interferes coming from other directions. The pattern of the direction selection can be fixed or adaptive. The adaptive selection is more attractive because it intends to maximize SNR depending on the sound environment. However, because the relative low frequency range of the audio applications, the existing adaptation techniques are effective only for microphone array with large physical dimension. For applications where physical dimension is limited, such as the case in hearing aid applications, the traditional adaptation based on the FIR adaptive filtering technique is not effective. As matter of a fact, because of this, most hearing aids that have directional processing can only give a fixed directional pattern which is effective in improving SNR in some conditions but less effective in other conditions.

FIG. 1 shows a typical direction processing system in a 2-mic hearing aid. The two microphones pick up sounds and convert them into electronic or digital signals. The signal form the second microphone is delayed and subtracted from the output of the first microphone. The result is a signal with interferes from certain directions being suppressed. In another word, the output signal is dependent on which directions the input signals come from. Therefore, the system is directional. The physical distance between the two microphones and the delay are two variables that control the characteristics of the directionality. For hearing aid applications, the physical distance is limited by the physical dimension of the hearing aid. The delay can be set in a delta-sigma A/D or using an all pass filter.

The term “polar pattern’ has been used to describe the characteristics of a directional system. FIG. 2 shows polar patterns corresponding to 3 delay values. The physical distance between the two microphones is fixed. When a sound source is at 0 degree, which is the direction along the axis of the two microphones and on the side of the front microphone, the system has a maximum output. When the sound source is away from 0 degree, the system output is reduced. The direction at which the system output has a maximum reduction is called directional null, which is related to what value the delay is set to. If the noise source is in the direction of 180°, the delay should be set to a value so that the polar pattern is a cardioids with the null at 180° (FIG. 2(a)). If the noise source is in the direction of 115°, the delay should be set to a value so that the polar pattern is a hyper-cardioids with the null at 115°(FIG. 2(b)). If the noise source is in the direction of 90°, the delay should be set to a value so that the polar pattern is a bi-directional with the null at 90° (FIG. 2(c)). Ideally, the delay should be set in such a way that the null is placed in the direction of the dominant noise source so that the noise can be suppressed mostly. If the direction of the noise source is known, the optima delay can be calculated as:

delay=d/c*cos(180°−q),

where d is distance of the two microphones, c is sound propagation speed, and q is direction angle in degree of the noise source.

One problem is that in many applications, the direction of the noise source is not known, and it is difficult to estimate because frequency of audio sounds is relative low. It is also difficult to adapt the directional null using the existing techniques. In fact, most hearing aids currently available in the market set the delay to a fixed value so that it has a fixed polar pattern for all conditions.

Thus, there is a need for improved approaches to adapt a directional null according to the source direction of interfere noise.

### SUMMARY OF THE INVENTION

Broadly speaking, the invention relates to improved approaches adaptively suppress interfering noise in a multi-microphone directional system. These approaches operate to adapt the direction null for the multi-microphone directional system.

One aspect of the invention pertains to techniques for adjusting a delay adaptively so that a directional null is placed in the direction of a dominant noise source. This would produce maximum Signal-to-Noise Ratio (SNR) improvement across all conditions. In other words, the dominant noise source is attenuated (e.g., suppressed) but the desired sound from a particular direction is not attenuated.

The invention can be implemented in numerous ways including as a method, system, apparatus, device, and computer readable medium. Several embodiments of the invention are discussed below.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a schematic of the directional processing in a 2-microphone hearing aid. The two microphones (mic1 and mic2) pick up sound and convert it into electronic signal. The electronic signal from mic2 is delayed (delay block) and subtracted (subtraction block) from the electronic signal of mic1. The output of the subtraction block is of directional property. That is, sound coming from certain direction is suppressed.

FIG. 2 shows three polar patterns of the directional processing, corresponding to 3 settings of the delay blocks in FIG. 1. FIG. 2(a) is called cardioids, corresponding to a delay of T, sound travel time from mic1 to mic2. FIG. 2(b) is called hyper-cardioids, corresponding to a delay of T*cos(180°−115°). FIG. 2(b) is called bi-directional, corresponding to a delay of 0.

FIG. 3 is a schematic of the proposed directional processing with adaptive optimal delay control. A feedback block called ‘optimal delay’ is added to the conventional directional processing shown in FIG. 1. The ‘optimal delay’ block takes the output of the directional processing system as its input and produces an optima delay value as its output. This optimal delay value is used as the new delay value for the directional processing.

FIG. 4 shows a block diagram of the optimal delay block. It consists two individual blocks: energy estimator and delay generator.

FIG. 5 is a detailed implementation of the delay generator of FIG. 4. The input to the delay generator is the energy estimate from energy estimator of FIG. 4. In FIG. 5(a), the energy estimate signal is delayed by a sample delay block to generate a signal similar to the energy signal but delayed in time. A sample delay block simply delays its input in time by a specified amount. The difference between the delayed and current energy signals is calculated by Sub block. The output of the Sub block is used as the input of block “calculation of delay increment”, which calculates the new delay increment. The new delay increment is added (“add” block”) to the previous output of the optimal delay, which is generated by passing the optimal delay signal through a sample delay block. The output of “add” block is limited in the range between “max delay” and “min delay” by the “min” and “max” block. The detailed implementations of block “calculation of delay increment” are shown in FIGS. 5(b), (c), and (d).

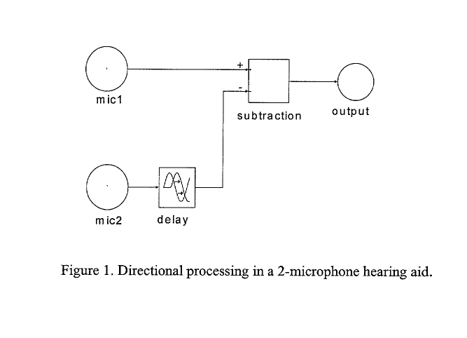

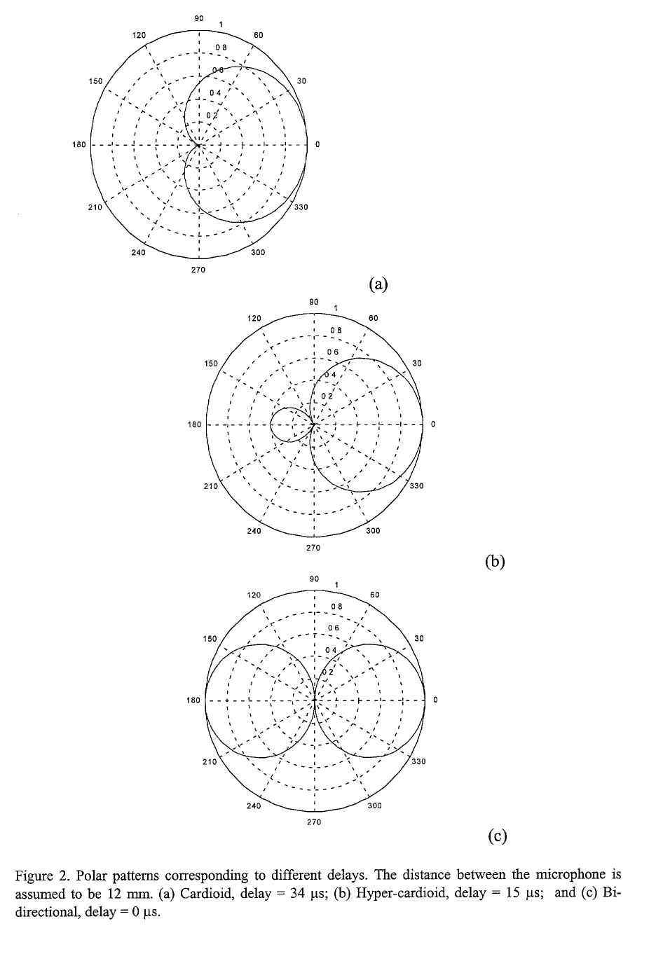

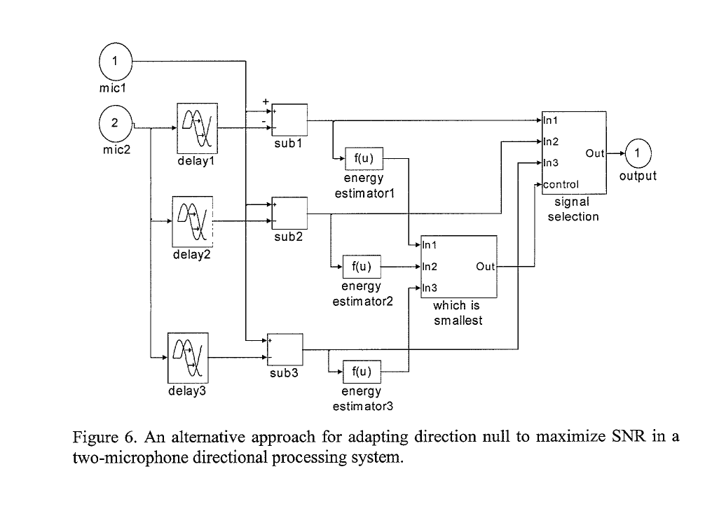

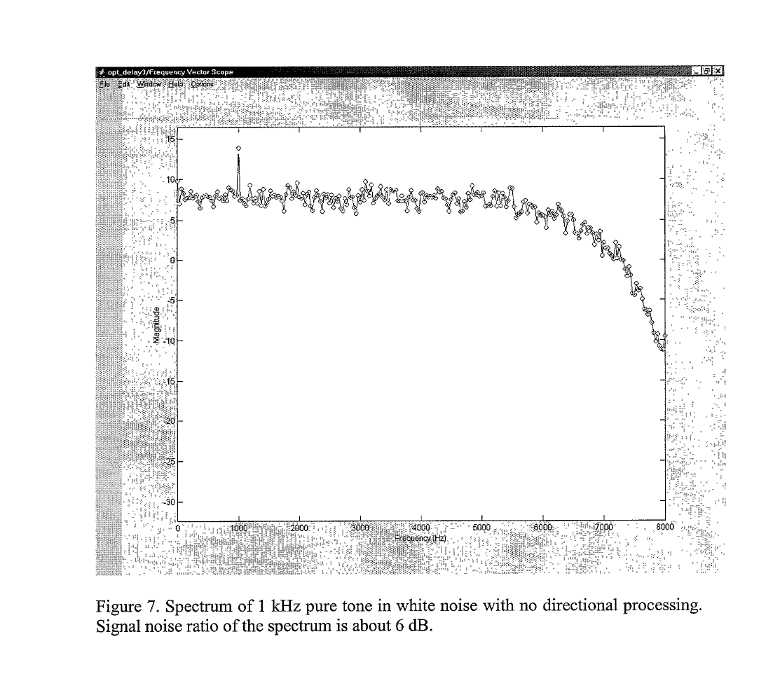

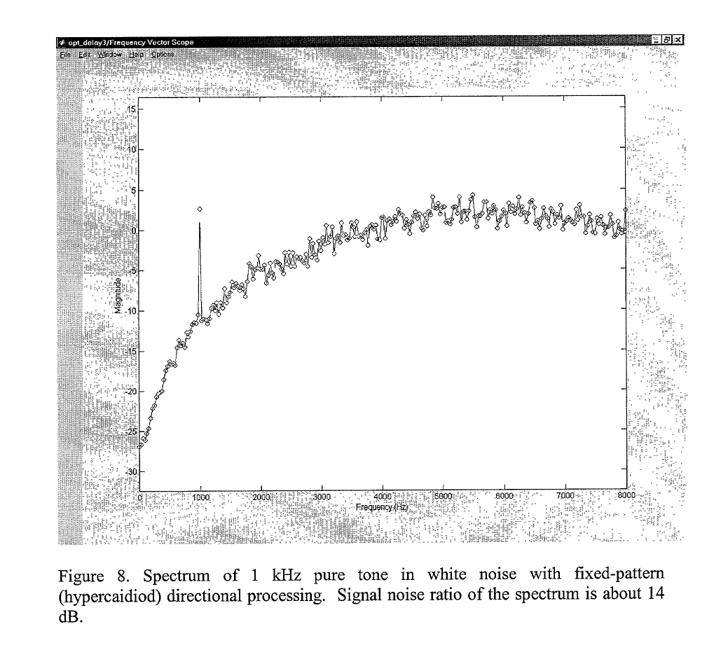

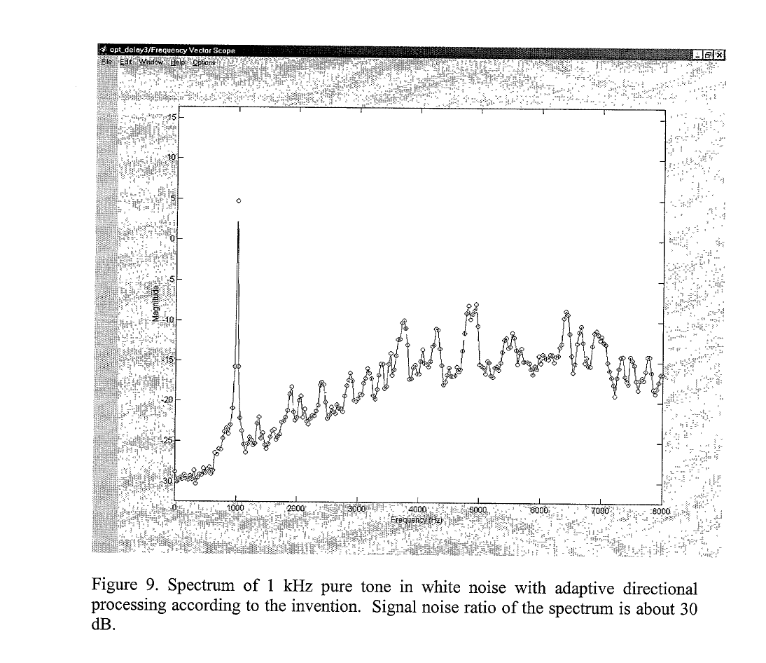

In FIG. 5(b), the input is used as the middle input of the “switch” block. If the middle input is equal to or greater than 0, the output of the switch (which is also the output of “calculation of delay increment”) is equal to the top input of the switch. If the middle input is less than 0, the output of the switch is equal to the lower input. The top input of the switch is its delayed output, generated by passing the output through a sample delay block. The lower input is the negative of the delayed output.

In FIG. 5(c), the input is simply multiplied with the delayed output to produce a new output (delay increment). Again, the delayed output is the result of the output signal passing through a sample delay block.

In FIG. 5(d), the input is scaled first and then multiplied with the delayed output to produce a new output.

FIG. 6 shows an alternative method for adapting the direction null to maximize SNR in a two-microphone directional processing system. The two microphones (mic1 and mic2) pick up sound and convert it into electronic signal. The electronic signal from mic2 is delayed with more than different delay values (delay1, delay2, and delay3). The delayed signals are subtracted from the electronic signal of mic1 to create more than one differential signal (output of sub1, sub2, and sub3). The energy of the differential signals is estimated by blocks “energy estimator1”, “energy estimator2”, and “energy estimator3”, respectively. The block “which is smallest” generate a number corresponding to the channel that has lowest energy. The number is used to control which differential signal should be used as final output of the directional processing system (“signal selection” block).

FIG. 7 is a graph illustrating a spectrum of a 1 kHz pure tone in white noise without any directional processing for noise reduction.

FIG. 8 is a graph illustrating a spectrum of a 1 kHz pure tone in white noise with fixed-pattern (hypercaidiod) directional processing for noise reduction.

FIG. 9 is a graph illustrating a spectrum of a 1 kHz pure tone in white noise with adaptive directional processing according to the invention for noise reduction.

### DETAILED DESCRIPTION OF THE INVENTION

The invention relates to improved approaches adaptively suppress interfering noise in a multi-microphone directional system. These approaches operate to adapt the direction null for the multi-microphone directional system.

One aspect of the invention pertains to techniques for adjusting a delay adaptively so that a directional null is placed in the direction of a dominant noise source. This would produce maximum Signal-to-Noise Ratio (SNR) improvement across all conditions. In other words, the dominant noise source is attenuated (e.g., suppressed) but the desired sound from a particular direction is not attenuated.

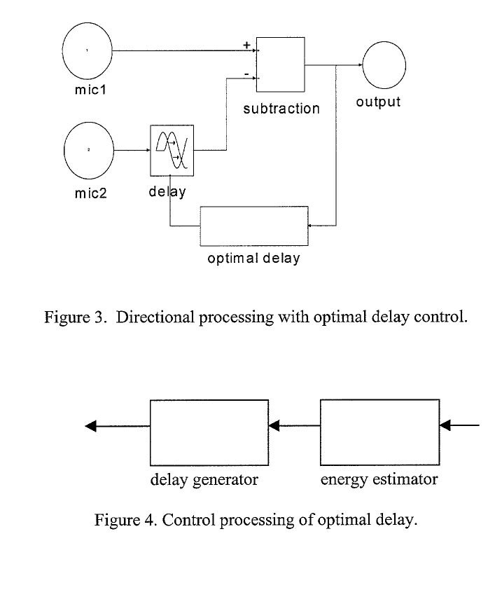

Embodiments of this aspect of the invention are discussed below with reference to FIGS. 3-9. However, those skilled in the art will readily appreciate that the detailed description given herein with respect to these figures is for explanatory purposes as the invention extends beyond these limited embodiments.

When interfere noise is present, the total energy of the signal picked up by a microphone is greater than the signal energy if the noise is not present. According to one embodiment, the delay value in the FIG. 3 is adjusted so that the output of the directional system has minimum energy. Because change in the delay does not change the system response to sounds coming from 0 degree, minimizing the output energy by adjusting the delay is equivalent to achieving a maximum attenuation of noise (assuming the desired sound is coming from the 0 degree).

The invented adaptive directional processing system consists at least two microphones physically spaced by a distance of at least 3 mm. The microphones are used to convert sound into electronic signal. The electronic signal can be either analog or digital. The system further consists a delay means to delay the electronic signals from one or both microphones. The system further consists an adding or subtraction means to generate a differential signal from delayed microphone outputs. The delay means is further controlled by a delay optimization means that self-adjusts the delay based on the output energy of the system (refer to FIG. 3).

The output of the directional processing system can be further processed by other processing function. In the case of hearing aid applications, the output of the directional processing is further processed by other hearing aid functions such as amplification and noise suppression.

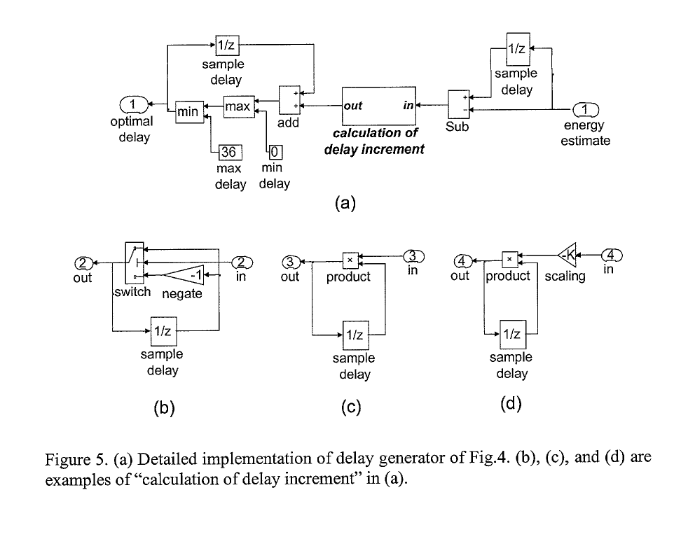

One preferred embodiment of the delay optimization means includes a means for creating an energy signal from the output of the directional processing system, and a means for using the energy signal to generate delay signal to control the delay of the output from one of the microphone in such a way that the output energy is statistically minimized, and therefore, the signal-to-noise ratio is maximized (FIG. 4).

The preferred embodiment of the means for creating the energy signal can be one of the followings: (1) forcing its input into positive signal; (2) squaring the input; (3) calculating a RMS signal for the input; or (4) estimating a minimum signal from the input. The energy signal can be down-sampled first before being used to generate the delay signal.

In one preferred embodiment of the means for using the energy signal to generate a delay signal, the changes in the energy signal is used to create a delay increment signal which is added to the current delay value to produce a new delay value. The new delay value can be limited to a range between a maximum delay value and a minimum delay value (FIG. 5(a)).

In one preferred embodiment, the change in the energy signal is calculated as the difference of the energy at a previous moment and the current moment. More specifically, it can be calculated as the difference between the previous sample and the current sample (FIG. 5(a)).

In another preferred embodiment of means for using the energy signal to generate a delay signal, the energy signal can be updated with different time constant from that of the delay signal. For example, for a fixed sampling rate, the energy signal can be updated for every sample, while the delay signal can be updated every 100 samples.

In one preferred embodiment of the means for calculating a delay increment signal, change in the energy signal is used to control a signal selection means for selecting one of two signals depending if the change is positive or negative. The first signal to be selected is the current delay increment signal. The second signal to be selected is the negative of the current delay increment signal (FIG. 5(b)).

In another preferred embodiment of the means for calculating a delay increment signal, change in the energy signal is multiplied with the current delay increment signal to produce a new delay increment signal (FIG. 5(c)).

Yet, in another preferred embodiment of the means for calculating a delay increment signal, change in the energy signal is scaled first and then multiplied with the current delay increment signal to produce a new delay increment signal (FIG. 5(d)).

Another method for adapting the null of the direction pattern to the direction of the dominant noise source is described as the following.

The adaptive directional processing system consists at least two microphones physically spaced by a distance of at least 3 mm. The microphones are used to convert sound into electronic signal. The electronic signal can be either analog or digital. The system further consists a delay means to delay the electronic signals from one or both microphones. The system further consists an addition or subtraction means to generate a differential signal of the microphone outputs as delayed by the delay means. The system also includes means for estimating the energy of the differential signal. The delay means, the addition/subtraction means, and the energy estimate means are used more than once in parallel so that multiple delayed signals, multiple differential signals, and multiple energy signals are created. The system further includes a means selecting one differential signal that has smallest energy as the system output (FIG. 6).

The output of the directional processing system can be further processed by other processing function. In the case of hearing aid applications, the output of the directional processing is further processed by other hearing aid functions such as amplification and noise suppression.

The preferred embodiment of the means for estimating signal energy can be one of the followings: (1) forcing its input into positive signal; (2) squaring the input; (3) calculating a RMS signal for the input; or (4) estimating a minimum signal from the input.

The invention is preferably implemented in hardware, but can be implemented in software or a combination of hardware and software. The invention can also be embodied as computer readable code on a computer readable medium. The computer readable medium is any data storage device that can store data which can be thereafter be read by a computer system. Examples of the computer readable medium include read-only memory, random-access memory, CD-ROMs, magnetic tape, optical data storage devices, carrier waves. The computer readable medium can also be distributed over a network coupled computer systems so that the computer readable code is stored and executed in a distributed fashion.

The advantages of the invention are numerous. Different embodiments or implementations may yield one or more of the following advantages. One advantage of the invention is that a dominant noise source can be directionally suppressed. Another advantage of the invention is that the directional suppression is adaptive and thus changes as the directional of the dominant noise source changes. Still another advantage of the invention is that desired sound from a particular direction is not interfered with even though a dominant noise source is able to be directionally suppressed.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. An adaptive directional sound processing system, comprising:
a least two microphones spaced apart by a predetermined distance, each of said microphones producing an electronic sound signal;
a delay circuit that delays the electronic sound signal from at least one of said microphones by an adaptive delay amount;
a subtraction circuit operatively connected to said microphones and said delay circuit, said subtraction circuit producing an output difference signal from the electronic sound signals following said delay circuit; and
a delay amount determination circuit operatively coupled to receive the output difference signal, said delay amount determination circuit produces a delay control signal that is supplied to said delay circuit so as to control the adaptive delay amount.

2. An adaptive directional sound processing system as recited in claim 1, wherein the adaptive delay amount varies so as to directionally suppress undesired sound.

3. An adaptive directional sound processing system as recited in claim 1, wherein the adaptive delay amount induced by said delay circuit operates to minimize the energy amount of the output difference signal.

4. An adaptive directional sound processing system as recited in claim 1, wherein the adaptive delay amount induced by said delay circuit operates to minimize the energy amount of the output difference signal while not significantly attenuating sound arriving at said microphones from a predetermined direction.

5. An adaptive directional sound processing system as recited in claim 1, wherein said adapting operates to minimize the energy amount of the output difference signal so as to maximize Signal-to-Noise Ratio (SNR).

6. An adaptive directional sound processing system as recited in claim 1, wherein said adaptive directional sound processing system resides within a hearing aid device.

7. An adaptive directional sound processing system, comprising:
a least two microphones spaced apart by a predetermined distance, each of said microphones producing an electronic sound signal;
a delay circuit that delays the electronic sound signal from at least one of said microphones by an adaptive delay amount;
a logic circuit operatively connected to said microphones and said delay circuit, said logic circuit producing an output signal from the electronic sound signals following said delay circuit; and
a delay amount determination circuit operatively coupled to receive the output signal, said delay amount determination circuit produces a delay control signal based on the output signal, the delay control signal being is supplied to said delay circuit so as to control the adaptive delay amount.

8. An adaptive directional sound processing system as recited in claim 7, wherein the adaptive delay amount varies so as to directionally suppress undesired sound.

9. An adaptive directional sound processing system as recited in claim 7, wherein the adaptive delay amount induced by said delay circuit operates to minimize the energy amount of the output signal.

10. An adaptive directional sound processing system as recited in claim 7, wherein the adaptive delay amount induced by said delay circuit operates to minimize the energy amount of the output signal while not significantly attenuating sound arriving at said microphones from a predetermined direction.

11. An adaptive directional sound processing system as recited in claim 7, wherein said adapting operates to minimize the energy amount of the output signal so as to maximize Signal-to-Noise Ratio (SNR).

12. An adaptive directional sound processing system as recited in claim 7, wherein said adaptive directional sound processing system resides within a hearing aid device.

13. An adaptive directional sound processing system as recited in claim 7, wherein the adaptive delay amount induced by said delay circuit is controlled such that a delay increment is added to a previously determined adaptive delay amount.

14. An adaptive directional sound processing system as recited in claim 13, wherein the delay increment is determined based on change in energy on the output signal.

15. An adaptive directional sound processing system as recited in claim 13, wherein the change in energy selects one of two possible delay increments.

16. An adaptive directional sound processing system as recited in claim 15, wherein the two possible delay increments are a previous delay increment and an inverse previous delay increment.

17. An adaptive directional sound processing system as recited in claim 13, wherein the delay increment is determined by multiplying a previous delay increment by a change in energy on the output signal.

18. An adaptive directional sound processing system as recited in claim 13, wherein the delay increment is determined by scaling a change in energy on the output signal and then multiplying a previous delay increment by the change in energy on the output signal.

19. An adaptive directional sound processing system, comprising:
a least two microphones spaced apart by a predetermined distance, each of said microphones producing an electronic sound signal;
a delay circuit that delays the electronic sound signal from at least one of said microphones by an adaptive delay amount;
logic means for producing an output signal from the electronic sound signals following said delay circuit; and
delay determination means for producing a delay control signal based on the output signal, the delay control signal being is supplied to said delay circuit so as to control the adaptive delay amount.

20. A method for adaptively controlling delay induced on a sound signal so that unwanted noise is directionally suppressed, said method comprising:
(a) producing a difference signal from at least first and second sound signals respectively obtained by first and second microphones;
(b) estimating an energy amount of the difference signal; and
(c) producing a delay signal to control a delay amount induced on at least one of the first and second sound signals based on the energy amount of the difference signal.

21. A method as recited in claim 20, wherein said method further comprises:
(d) inducing the delay amount on at least one of the first and second sound signals.

22. A method as recited in claim 21, wherein following said inducing (d) said method (e) repeats said operations (a)-(d) so that the delay amount is dynamically adjusted so as to directionally suppress the unwanted noise.

23. A method as recited in claim 20, wherein the sound signal is provided by a hearing aid, and wherein said method is performed by the hearing aid.

24. An adaptive delay method for directional noise suppression in a hearing aid device, the hearing aid device having at least first and second microphones, said method comprising:
receiving first and second microphone outputs;
delaying at least the second microphone output by an adaptive delay amount;
combining the first microphone output and the delayed second microphone output to produce an output signal;
estimating an energy amount associated with the output signal;
adapting the adaptive delay amount based on the energy amount.

25. A method as recited in claim 24, wherein said adapting operates to minimize the energy amount of the output signal while not significantly attenuating sound arriving at the first and second microphones from a predetermined direction.

26. A method as recited in claim 24, wherein said adapting operates to minimize the energy amount of the output signal so as to maximize Signal-to-Noise Ratio (SNR).

27. A method as recited in claim 24, wherein said combining comprises adding the first microphone output and the delayed second microphone output.

28. A method as recited in claim 24, wherein said combining comprises subtracting the first microphone output and the delayed second microphone output.

29. A method as recited in claim 24, wherein said adapting determines the adaptive delay amount based on change in energy on the output signal.

30. A method as recited in claim 29, wherein the change in energy on the output signal selects one of two possible delay increments.

31. A method as recited in claim 30, wherein the two possible delay increments are a previous delay increment and an inverse previous delay increment.

32. A method as recited in claim 24, wherein said adapting of the adaptive delay amount comprises multiplying a previous delay increment by a change in energy on the output signal.

33. A method as recited in claim 24, wherein said adapting of the adaptive delay amount comprises scaling a change in energy on the output signal and then multiplying a previous delay increment by the change in energy on the output signal.
